(19) United States
(12) Patent Application Publication
(10) Pub. No.: US 2024/0286378 A1
(43) Pub. Date: Aug. 29, 2024

(54) COMPOSITE FILMS FOR MOBILE ELECTRONIC DEVICE COMPONENTS

(71) Applicants: SOLVAY SPECIALTY POLYMERS USA, LLC, Alpharetta, GA (US); Cytec Industries Inc., Princeton, NJ (US)

(72) Inventors: Nan Chen, Cumming, GA (US); Lewis Karl Williams, Cumming, GA (US); Marco Apostolo, Senago (mi) (IT); Val Glade Gunther, South Jordan, UT (US)

(73) Assignees: SOLVAY SPECIALTY POLYMERS USA, LLC, Alpharetta, GA (US); Cytec Industries Inc., Princeton, NJ (US)

(21) Appl. No.: 18/569,154

(22) PCT Filed: Jun. 9, 2022
(86) PCT No.: PCT/EP2022/065766

§ 371 Date: Dec. 11, 2023

Related U.S. Application Data
(63) Continuation of application No. 63/209,427, filed on Jun. 11, 2021.

(30) Foreign Application Priority Data
Sep. 7, 2021 (EP) 21195291.6

(51) Int. Cl. B32B 5/02; B32B 15/14; B32B 15/20; C08J 5/24

(52) U.S. Cl. CPC B32B 5/024; B32B 15/14; B32B 15/20; C08J 5/244; B32B 2250/02; B32B 2260/021; B32B 2260/046; B32B 2262/101; B32B 2307/204; B32B 2307/54; B32B 2307/718; B32B 2307/7376; C08J 2327/18

(57) ABSTRACT

The present disclosure relates to a composite film made of at least one fluoropolymer and a fiber fabric, presenting a thickness of less than 0.10 mm, as well as articles comprising such composite films, exhibiting low dielectric constant and dissipation factors and being suitable for mobile electronic device components, for example flexible printed circuit board (FPC).

This application claims priority from U.S. provisional patent application No. 63/209,427 filed on 11 Jun. 2021 and from EP21195291.6 filed on 7 Sep. 2021, the whole content of each of these applications being incorporated herein by reference for all purposes.

### TECHNICAL FIELD

The present disclosure relates to composite films presenting a thickness of less than 0.10 mm, comprising at least one fluoropolymer, and at least one fiber fabric, such composite films being flexible due to their thickness, and exhibiting low dielectric constant and dissipation factors, making them well-suited for mobile electronic device components, for example copper clad laminate (CCL) and flexible printed circuit boards (FPC).

### BACKGROUND

Due to their reduced weight and high mechanical performance, polymer compositions are widely used to manufacture mobile electronic device components. There is now a high demand from the market for polymer compositions to be used to manufacture mobile electronic device components having improved dielectric performances (i.e. low dielectric constants and dissipation factor).

In mobile electronic devices, the material forming the various components and housing can significantly degrade wireless radio signals (e.g. 1 MHz, 2.4 GHZ and 5.0 GHz frequencies) which are transmitted and received by the mobile electronic device through one or more antennas. The dielectric performances of the material to be used in mobile electronic devices can be determined by measuring the dielectric constant and the dissipation factor. They represent the ability of the material to interact with the electromagnetic radiation and disrupt electromagnetic signals (e.g. radio signals) travelling through the material. Accordingly, the lower the dielectric constant of a material at a given frequency, the less the material disrupts the electromagnetic signal at that frequency.

Polymer films are employed in the domain of mobile electronic device. For example, aromatic polyimide films in the form of a continuous aromatic polyimide film/copper foil laminate structure have been described for manufacturing flexible printed circuit boards (FPC), carrier tapes for tape-automated-bonding (TAB), and tapes of lead-on-chip (LOC) structure. Such films are presented as showing good high temperature resistance, good chemical properties, high electrical insulating property, and high mechanical strength. However, polyimide films do not show the expected dielectric performances, especially the dissipation factor of polyimide films is too high to be used in applications at high frequency (≥20 GHZ). In addition, the dissipation factor at high frequency of polyimide films gets even worse under humid environment, due to the moisture absorption.

An object of the present invention is to provide a composite film having improved dielectric performances. Such a composite film is made of a fluoropolymer and a fiber fabric.

U.S. Pat. No. 8,741,790 relates to a PTFE/fiberglass composites useful as conveyor belts. Conveyor belts made from PTFE resins are used in many various applications. Because many of the applications rely on heat being transferred through the belts, belt thicknesses are preferably kept to a minimum. As decsribed in the document hicknesses typically range from as low as 5 mils (i.e. 0.127 mm) to possibly as high as 20 mils (i.e. 0.508 mm).

The films described in this document are however not suited for mobile electronic device components, such as copper clad laminate (CCL) and flexible printed circuit boards (FPC).

WO2007/024837A2 discloses a composite structure comprising glass cloth and melt-processible fluoropolymer, the entire thickness of the glass cloth being embedded in the fluoropolymer, said fluoropolymer containing an effective amount of adhesive agent to improve the adhesion of the composite structure to a copper layer. WO2007/024837A2 provides no indication on the dielectrical properties of the glass cloth used in the composite structure.

EP3489299A1 discloses a method for producing a film or a laminate using a liquid composition comprising a liquid medium and a resin powder dispersed in the liquid medium, and characterized in that the average particle size of the resin powder is from 0.3 to 6 μm, the volume-based cumulative 90% diameter of the resin powder is at most 8 μm, and the resin powder is a resin containing a fluorinated copolymer comprising units comprising a functional group selected from the group consisting of a carbonyl group-containing group, a hydroxy group, an epoxy group and an isocyanate group. EP3489299A1 does not disclose a method wherein the film or laminate is obtained using a dry powder of the fluorinated polymer.

JP2020083990A discloses a method for manufacturing a composite which includes: impregnating a liquid dispersion obtained by dispersing powder containing an oxygen atom-containing tetrafluoroethylene-based polymer in a solvent, into an opened glass cloth to which an amino group is introduced; heating the dispersion liquid; and fixing the tetrafluoroethylene-based polymer to the glass cloth. The opened glass cloth to which an amino group is introduced is preferably obtained by contact treatment to an opened glass cloth of a silane coupling agent having an amino group, or plasma treatment of an opened glass cloth in a nitrogen-containing atmosphere. JP2020083990A does not disclose a method wherein the composite is obtained using a dry powder of the tetrafluoroethylene-based polymer polymer.

### SUMMARY

The present invention relates to a composite film presenting a thickness of less than 0.10 mm, the composite film comprising:
at least one fluoropolymer comprising recurring units derived from tetrafluoroethylene, [Polymer (FP)], and
at least one fiber fabric, [fiber fabric (F)].

In a preferred embodiment, the composite film comprises a glass fiber fabric which is a low dielectric constant, low dissipation factor glass fiber fabric.

The present invention also relates to methods for preparing such composite films.

Others objects of the present invention are as follows: articles or components article, comprising at least one composite film of the present invention, use of at least one such composite film to prepare a mobile electronic device article or component, for example a flexible printed circuit board (FPC) and use of a powder of Polymer (FP), as defined above, to prepare a composite film having a thickness of less than 0.10 mm, said Polymer (FP) comprising recurring units derived from tetrafluoroethylene and said composite film further comprising at least one fiber fabric (F).

### DISCLOSURE OF THE INVENTION

In the present application:
any description, even though described in relation to a specific embodiment, is applicable to and interchangeable with other embodiments of the present invention;
where an element or component is said to be included in and/or selected from a list of recited elements or components, it should be understood that in related embodiments explicitly contemplated here, the element or component can also be any one of the individual recited elements or components, or can also be selected from a group consisting of any two or more of the explicitly listed elements or components; any element or component recited in a list of elements or components may be omitted from such list;
any recitation herein of numerical ranges by endpoints includes all numbers subsumed within the recited ranges as well as the endpoints of the range and equivalents; and
the term “and/or” used in a phrase in the form of “A and/or B” means A alone, B alone, or A and B together.

### Composite Film

The present invention relates to a composite film having a thickness of less than 0.10 mm, said composite film comprising:
at least one fluoropolymer comprising recurring units derived from tetrafluoroethylene, Polymer (FP) hereinafter, and
at least one fiber fabric, fiber fabric (F) hereinafter.

The composite films of the present invention are characterized in that they are flexible in comparison to the films available on the market. Because of their low thickness, the chemical nature of the resin used to prepare the film, in combination with the fiber fabric, the films of the present invention not only present the appropriate flexibility for mobile electronic device components, but they do also present the right set of mechanical properties, including tensile strength and coefficient of thermal expansion. The composite films of the invention are also advantageously characterised by excellent dielectric properties for use in mobile electronic device components. In particular, they are characterised by low dielectric constant and low dissipation factors even at high frequencies.

The composite film has a thickness comprised between 0.10 mm and 0.005 mm, preferably between 0.09 and 0.01 mm, for example between 0.08 and 0.02 or between 0.07 and 0.03 mm. The thickness of the composite film can be measured by any means. For example, it can be measured using a thickness gage. The inventors have realized that such thickness is technically relevant. A composite film with a thickness in the claimed range keeps the required bendability for the application, while at the same time it maintains its shape, thanks to the fiber fabric. This combination of properties make the inventive films well-fitted for use as mobile electronic device component, such as copper clad laminate (CCL) and flexible printed circuit boards (FPC).

Polymer (FP) used in the composite film of the present invention comprises recurring units derived from tetrafluoroethylene (TFE).

In some embodiments, Polymer (FP) used in the composite film of the present invention is polytetrafluoroethylene (PTFE). PTFE offers excellent chemical resistance properties, high temperature capabilities, and good release characteristics.

For the purpose of the present invention, polytetrafluoroethylene (PTFE) is a per(halo)fluoropolymer having at least 98 mol. % of recurring units derived from tetrafluoroethylene, at least 98.5 mol. %, at least 99 mol. %, at least 99.5 mol. % or at least 99.9 mol. % of recurring units derived from tetrafluoroethylene, the mol. % being based on the total number of moles in the Polymer (FP). Preferably, Polymer (FP) comprise 100 mol. % of recurring units derived from tetrafluoroethylene, based on the total number of moles in the polymer.

When all the recurring units of the PTFE derive from tetrafluoroethylene, the PTFE may then be qualified as a “homopolymer”.

According to another embodiment, the PTFE comprises up to 2 mol. % of recurring units derived from an ethylenically unsaturated fluorinated monomer distinct from tetrafluoroethylene, typically up to 1 mol. %, up to 0.5 mol. % or up to 0.1 mol. % of recurring units derived from an ethylenically unsaturated monomer distinct from tetrafluoroethylene, based on the total number of moles in the polymer.

PTFE polymers well-suited for the present invention are generally provided as micropowders, which may be obtained by irradiation of standard high molecular weight PTFE or modified PTFE, and which are generally known for possessing a considerably lower molecular weight than the typical molecular weight of standard high molecular weight/high melt viscosity PTFEs/modified PTFEs. This enables the micropowders of PTFEs and/or modified PTFE to be by themselves melt-flowable.

Preferably, Polymer (FP) is selected from the group consisting of modified PTFE micropowders having a melt viscosity of at most 1.5×10³ Pa·s, as measured according to ASTM D3835 at 372° C. and 1000 s⁻¹ using a Hastelloy die of 1 mm×10 mm. The melt viscosity can be at most 1.4×10³ Pa·s, at most 1.3×10³ Pa·s, at most 1.0×10³ Pa·s or at most 0.8×10³ Pa·s.

Micropowders of Polymer (FP), e.g. PTFE or of modified PTFE, well-suited for the present invention, can be characterized by their average particle size d₅₀, determined by laser light diffraction according to ISO 13320. According to an embodiment, the d₅₀ of Polymer (FP) micropowder is of at most 25.0 μm, for example at most 22.0 μm or at most 20.0 μm. Lower boundary for d₅₀ is not particularly limited. It is nevertheless understood that to the sake of convenience in handling, d₅₀ of Polymer (FP) micropowders is generally of at least 0.5 μm, preferably at least 1.0 μm.

Particularly good results have been obtained with micropowders of PTFE or of modified PTFE possessing an average size d₅₀ of between 2.0 μm and 15.0 μm, preferably of between 2.5 μm and 12.0 μm.

The average size d₅₀ of micropowders PTFE or of modified PTFE, is determined according to ISO 13320 by laser light diffraction, for instance using a laser diffraction particle size LS™ 13 320 MW-Beckman Coulter instrument.

A PTFE micropowder, which can be used in the film of the present invention, is POLYMIST® PTFE micronized powder commercially available from Solvay Specialty Polymers USA, LLC.

In some other embodiments, Polymer (FP) used in the composite film of the present invention comprises, in addition to recurring units derived from tetrafluoroethylene, recurring units derived from at least one fluorinated monomer different from tetrafluoroethylene. This at least one additional monomer may be selected from the group consisting of:
perfluoroalkylvinylethers of formula CF₂═CFOR_{f} wherein R_{f} is a C1-C6 perfluoroalkyl group, preferably a C1-C3 perfluoroalkyl group;
perfluoro-oxyalkylvinylethers of formula CF₂═CFOX₀, wherein X₀ is a C1-C12 perfluorooxyalkyl group comprising one or more ether groups, such as perfluoro-2-propoxy-propyl group;
C3-C8 perfluoroolefins, such as hexafluoropropene (HFP); and
perfluorodioxoles of formula (I):

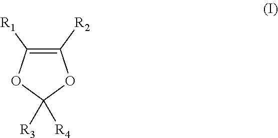

wherein R₁, R₂, R₃ and R₄, equal to or different from each other, are independently selected from the group consisting of—F, a C1-C6 fluoroalkyl group, optionally comprising one or more oxygen atoms, and a C1-C6 fluoroalkoxy group, optionally comprising one or more oxygen atoms.

According to these embodiments, Polymer (FP) preferably comprises recurring units derived from tetrafluoroethylene and at least 1.5 mol. %, for example at least 5.0 mol. %, or at least 7.0 mol. % of recurring units derived from at least one fluorinated monomer different from tetrafluoroethylene, based on the total number of moles in Polymer (FP).

According to these embodiments, Polymer (FP) preferably comprises recurring units derived from tetrafluoroethylene and at most 30.0 mol. %, for example at most 25.0 mol. % by weight, or at most 20.0 mol. % by weight of recurring units derived from at least one fluorinated monomer different from tetrafluoroethylene, based on the total number of moles in Polymer (FP).

In some advantageous embodiments, Polymer (FP) is selected from the group consisting of the copolymers of tetrafluoroethylene and perfluoroalkylvinyl ethers, of formula CF₂═CFOR_{f} wherein R_{f} is a C1-C6 perfluoroalkyl group, preferably a C1-C3 perfluoroalkyl group.

Polymer (FP) may be advantageously selected from the group of the tetrafluoroethylene/perfluoroalkylvinylether copolymers comprising:
3.0 to 6.0 mol. % of recurring units derived from a perfluoroalkylvinylether selected from perfluoromethylvinylether, prefluoroethylvinylether and perfluoroproylvinylether, and
from 94.0 to 97.0 mol. % of recurring units derived from tetrafluoroethylene, based on the total number of moles in Polymer (FP).

Polymer (FP) is preferably selected from the copolymers comprising:
3.0 to 6.0 mol. % of recurring units derived from perfluoromethylvinylether, or perfluoropropylvinylether, and
from 94.0 to 97.0 mol. % of recurring units derived from tetrafluoroethylene, based on the total number of moles in Polymer (FP).

Preferably, Polymer (FP) is selected from the group consisting of tetrafluoroethylene/perfluoroalkylvinylether copolymers, preferably a tetrafluoroethylene/perfluoromethylvinylether or a tetrafluoroethylene/perfluoropropylvinylether copolymer. More preferably it is selected from the tetrafluoroethylene/perfluoroalkylvinylether copolymers, preferably a tetrafluoroethylene/perfluoromethylvinylether or a tetrafluoroethylene/perfluoropropylvinylether copolymer, having a melt viscosity of at most 1.8×10³ Pa·s, as measured according to ASTM D3835 at 372° C. and 100 s⁻¹ using a Hastelloy die of 1 mm×10 mm, for example at most 1.7×10³ Pa·s, at most 1.6×10³ Pa·s, at most 1.5×10³ Pa·s or at most 1.4×10³ Pa·s.

Non-limitative examples of suitable Polymer (FP) include notably those commercially available under the trademark name HYFLON® PFA P and M series and HYFLON® MFA from Solvay Specialty Polymers Italy S.p.A.

According to the present invention, fiber fabric (F) used in the composite film may be an aramid fabric, a glass fiber fabric, or a quartz fabric.

Preferably, fiber fabric (F) comprises glass fibers. More preferably the glass fibers, and consequently the glass fiber fabric, are characterised by low dielectric constant and low dissipation factor.

In an advantageous embodiment, the glass fiber fabric is made of fibers comprising at least 33.0 parts by mass to 48.0 parts by mass of silicon oxide; 1.0 parts by mass to 5.0 parts by mass of alumina; 5.0 parts by mass to 10.0 parts by mass of titanium oxide; 0.5 parts by mass to 4.0 parts by mass of zirconium oxide; and at least one of the following oxides holmium oxide, alkaline earth metal oxides, neodymium oxide, and iron oxide.

In certain embodiments, the glass fiber fabric is made of fibers having the following composition: silicon oxide, 35.0 parts by mass to 48.0 parts by mass; alumina, 1.0 parts by mass to 5.0 parts by mass; titanium oxide 5.5 parts by mass to 10.0 parts by mass; zirconium oxide, 0.5 parts by mass to 4.0 parts by mass; holmium oxide, less than or equal to 3.0 parts by mass; alkaline earth metal oxides, 32.0 parts by mass to 47.5 parts by mass, with respect to the total mass of the fiber. Alternatively, the glass fiber fabric is made of fibers having the following composition: silicon oxide, 33.0 parts by mass to 46.0 parts by mass; alumina, 1.5 parts by mass to 5.0 parts by mass; titanium oxide, 5.0 parts by mass to 10.0 parts by mass; zirconium oxide, 0.5 parts by mass to 4.0 parts by mass; neodymium oxide, less than or equal to 2.5 parts by mass; iron oxide, less than or equal to 1.2 parts by mass; alkaline earth metal oxide, 31.0 parts by mass to 53.0 parts by mass, with respect to the total mass of the fiber.

The glass fiber fabric may additionally or alternatively be characterized by a dielectric constant Dₖ at 1 GHZ, measured using a transmission line method and a vector network analyzer, of less than 5.5 and a dissipation factor D_{f} at 1 GHz, measured using a transmission line method and a vector network analyzer, of less than 0.0030.

The glass fiber fabric preferably has a dielectric constant Dₖ at 1 GHZ, measured using a transmission line method and a vector network analyzer, of less than 5.0. The dielectric constant Dₖ at 1 GHZ, is generally not less than 3.0. The glass fiber fabric preferably has a dissipation factor D_{f} at 1 GHZ, measured using a transmission line method and a vector network analyzer, of less than 0.0025, even less than 0.0020. The dissipation factor D_{f} at 1 GHz is generally not less than 0.0001.

Glass fiber fabrics with the properties detailed above are available from Nittobo as well as from CTG Taishan Fiberglass.

The fiber fabric (F) may be a woven or non wowen fabric. The fiber fabric (F) may for example present an average thickness of about 200 μm or less, for example of 180 μm or less or of 160 μm or less. The fibers in the fiber fabric (F) may present an average diameter of about 25 μm or less, for example of about 23 μm or less or of 21 μm or less.

In some embodiments, the fiber fabric (F) is such that it has an average area weight (in grams per square meter or g/m²) comprised between 10 g/m² and 100 g/m², for example between 12 g/m² and 90 g/m² or between 15 g/m² and 80 g/m².

In some embodiments, fiber fabric (F) is such that it has a thickness between 0.01 mm and 0.09 mm, even a thickness between 0.02 mm and 0.07 mm.

The use of such fiber fabric in the film of the invention is advantageous, as it brings additional stiffness or dimensional stability if required. These features can be advantageously optimized based on the choice of certain fabrics, in order to fit certain end-use requirements.

The composite film presenting a thickness of less than 0.10 mm may be a multi-layer composite film and may comprise several fiber fabrics (F), each being identical or distinct. The fabrics may be of distinct thickness and/or of different composition. They may also be oriented in different direction. For example, the composite film may comprise a stack of 2, 3, 4, 5 and up to 10 fiber fabrics.

In the multi-layered film of the present invention, the same Polymer (FP) comprising recurring units derived from tetrafluoroethylene described herein may be present between each fiber fabric, or distinct Polymers (FP) may be used between each fiber fabric. Alternatively, chemically distinct polymers may be used to bond the layers together. Examples of such chemically distinct polymers are polyimide and liquid-crystalline polymers.

According to the present invention, the composite film preferably comprises less than about 75 wt. % of fiber fabric (F), preferably between 5 and 70 wt. % or between 10 and 60 wt. % of fiber fabric (F) per unit area of the composite film. At such weight percentages, the composite film readily accommodates contraction of the fluoropolymer (e.g. PTFE, PFA films) as the composite film is cooled from elevated temperatures.

According to the present invention, the composite film is preferably such that its volume of fiber (V_{f}) is between 20 and 60 vol. %, for example between 25 and 55 vol. %, or from 30 and 50 vol. %, wherein V_{f} is calculated according to the following equation:

$${V}_{f} = \frac{V olume of fiber}{Volume of fiber + V olume of polymer}$$

The composite films of the present invention exhibit some advantageous dielectric properties. In some embodiments, the composite films have the following dielectric properties:
a dielectric constant Dk at 5 GHz equal to or less than 3.5, less than 3.0, even less than 2.8, preferably less than 2.5, as measured by Split Post Dielectric Resonator (SPDR), IEC 61189-2-721:2015 after drying 1 h at 100° C., and/or
a dissipation factor Df at 5 GHz of less than 0.0050, less than 0.0040, less than 0.0030, even less than 0.0020, as measured by Split Post Dielectric Resonator (SPDR), IEC 61189-2-721:2015 after drying 1 h at 100° C., and/or
a dielectric constant Dk at 20 GHz of less than 3.0, even less than 2.5, as measured by Split Cylinder Resonator, IPC TM-650 2.5.5.13 after drying 1 h at 100° C., and/or
a dissipation factor Df at 20 GHz of less than 0.0100, even less than 0.0080, as measured by Split Cylinder Resonator, IPC TM-650 2.5.5.13 after drying 1 h at 100° C., and/or
a dielectric constant Dk at 5 GHz of less than 3.5, even less than 3.0, as measured by Split Post Dielectric Resonator (SPDR), IEC 61189-2-721:2015 after immersion in water for 24 hours, and/or
a dissipation factor Df at 5 GHz of less than 0.005, even less than 0.004, as measured by Split Post Dielectric Resonator (SPDR), IEC 61189-2-721:2015 after immersion in water for 24 hours, and/or
dielectric constant Dk at 20 GHz of less than 3.0, even less than 2.9, as measured by Split Cylinder Resonator, IPC TM-650 2.5.5.13 after immersion in water for 24 hours, and/or
a dissipation factor Df at 20 GHz of less than 0.0300, even less than 0.0100 as measured by Split Cylinder Resonator, IPC TM-650 2.5.5.13 after immersion in water for 24 hours.

In some embodiments, the composite films may have the following combination of dielectric properties:
a dielectric constant Dk at 5 GHz of less than 3.0, even less than 2.8, as measured by Split Post Dielectric Resonator (SPDR), IEC 61189-2-721:2015 after drying 1 h at 100° C., and
a dissipation factor Df at 5 GHz of less than 0.0030, even less than 0.0020, as measured by Split Post Dielectric Resonator (SPDR), IEC 61189-2-721:2015 after drying 1 h at 100° C., and
a dielectric constant Dk at 20 GHz of less than 2.8, as measured by Split Cylinder Resonator, IPC TM-650 2.5.5.13 after drying 1 h at 100° C., and/or
a dissipation factor Df at 20 GHz of less than 0.0080, as measured by Split Cylinder Resonator, IPC TM-650 2.5.5.13 after drying 1 h at 100° C., and/or
a dielectric constant Dk at 5 GHz of less than 3.5, even less than 3.0, as measured by Split Post Dielectric Resonator (SPDR), IEC 61189-2-721:2015 after immersion in water for 24 hours, and/or
a dissipation factor Df at 5 GHz of less than 0.0050, even less than 0.0040, as measured by Split Post Dielectric Resonator (SPDR), IEC 61189-2-721:2015 after immersion in water for 24 hours, and/or
dielectric constant Dk at 20 GHz of less than 3.0, even less than 2.9, as measured by Split Cylinder Resonator, IPC TM-650 2.5.5.13 after immersion in water for 24 hours, and/or
a dissipation factor Df at 20 GHz of less than 0.0300, even less than 0.0100 as measured by Split Cylinder Resonator, IPC TM-650 2.5.5.13 after immersion in water for 24 hours.

In some embodiments, the composite films may have the following combination of dielectric properties:
a Dk 5 GHz of less than 2.5; and/or
a Df 5 GHz of less than 0.0015; and/or
a Dk 20 GHz of less than 2.5; and/or
a Df 20 GHz of less than 0.0050; and/or
a Dk 50 GHz of less than 3.0, even less than 2.8; and/or
a Df 50 GHz of less than 0.0030, even less than 0.0025; and/or
a Dk 75 GHz of less than 3.0, even less than 2.8; and/or
a Df 75 GHz of less than 0.0030, even less than 0.0025; and/or
a Dk 100 GHz of less than 3.0, even less than 2.8; and/or
a Df 100 GHz of less than 0.0030, even less than 0.0025,
wherein the Dk is measured by Split Cylinder Resonator, IPC TN-650 2.5.5.13 after drying 1 h at 100° C. and the D_{f} is measured by Split Post Dielectric Resonator (SPDR), IEC 61189-2-721:2015 after drying 1 h at 100° C.

In some embodiments, the film is such that it has a coefficient of thermal expansion (CTE) over a temperature range of 0° C. to 300° C. of less than about 50×10⁻⁶/° C., for example less than 40×10⁻⁶/° C. or less than 30×10⁻⁶/° C. According to this embodiment, the film is such that it has a CTE of at least 1×10⁻⁶/° C. or at least 4×10⁻⁶/° C.

### Method for Preparing the Composite Film

The composite film of the present invention may be prepared by several distinct embodiments.

Several of these methods may start from a polymer powder comprising at least one Polymer (FP) which is applied to at least one surface of fiber fabric (F). According to these methods, the powder of the at least one Polymer (FP) applied to at least one surface of the fiber fabric is such that its d₅₀ is comprised between 0.1 and 100 μm, preferably between 1 and 90 μm or between 5 and 80 μm. The d₅₀ of the powder of Polymer (FP) can be measured by laser scattering in isopropanol. The polymer powder may include fillers and other additives well known in the art. Such fillers and additives may include, for example, organic or inorganic particles, plasticizers, light and weathering stabilizers, antistatic agents, ultraviolet absorbing agents, dyes, pigments, viscosity agents and lubricants.

One of the method of the present invention for preparing a composite film presenting a thickness of less than 0.1 mm comprises the steps of:
a) applying a powder comprising at least one Polymer (FP) to at least one surface of a fiber fabric, wherein the powder comprising at least one Polymer (FP) has a d₅₀ comprised between 0.1 and 100 μm,
b) bonding the powder of the at least one Polymer (FP) to the fiber fabric at a pressure P of at least 0.3 MPa and/or a temperature T such that T≥Tm, wherein Tm is the melting temperature of the polymer powder (° C.).

At the temperature and pressure referenced above, the polymer powder undergoes a phase transition, typically melting, enabling it to bond securely to the fiber fabric.

In some preferred embodiments, the powder of Polymer (FP) is applied to both surfaces of the fiber fabric. Protective films may be used to apply powder of Polymer (FP) to both surfaces of the fiber fabric.

Preferably, step b) is performed at a pressure P of at least 0.4 MPa, at least 0.5 MPa or at least 0.5 MPa, and/or at a temperature T such that T≥Tm, wherein Tm is the melting temperature of the polymer powder (C). In some embodiments, T is such that T≥Tm+5° C. In some embodiments, T is such that 310° C.≤T≤T400° C., for example 320° C.≤T≤T390° C. or 325° C.≤T≤T380° C. or 330° C.≤T≤T360° C.

Step b) may for example consists in subjecting the fiber fabric with the polymer powder applied thereto to compression molding using a hot press.

If a molding press is used in the method of the present invention, a release film between the film and the platen of the press may be used, so that no sticking of the film to the platen occurs. Any release film, which does not interfere with or alter the characteristics of the composite film, is suitable. The release film can be a polyimide, or a release coated metal foil such as aluminum, for example.

This process can be a batch process, meaning that individual films can be formed one at a time with a stack press, in an autoclave or in a vacuum/oven, for example, or a continuous process in which polymer powder is continuously laid over at least one fiber fabric, with or without one or more rolls of fiber fabric, and bonded thereto by means of high pressure and temperature with a double belted press, for example. The residence time in the press when the polymer powder is above its melting point is 0.5 to 1,000 sec. The typical double belt press may have a heating and cooling zone.

The amount of pressure and temperature applied to the film depends upon the type of polymer employed and upon the fiber fabric employed and the physical and dimensional properties of each, along with the operational, physical and dimensional properties of the press. The melt point of the polymer powder is an important feature along with the size of the polymer powder, the thickness of the fiber fabric as well as its ability to transfer heat, and of course how thick the composite film is (including multi-layered structures). Also, the heat transfer characteristics of the platen (of the press), its size and thickness, residence time of the film in the press, etc. are very important. For example, with a polymer powder comprising a tetrafluoroethylene/perfluoroalkylvinylether copolymer as described above, the temperature should be above approximately 305° C. A particularly preferred temperature range is approximately 330° C. to 360° C. While employing this particular polymer along with a fiber fabric having an average thickness of approximately 0.06 mm, the pressure to be applied to such a composite film should be in the range of from 0.3 MPa to 1.0 MPa.

One of the method of the present invention for preparing a composite film presenting a thickness of less than 0.1 mm comprises the steps of:
a) applying a polymer powder comprising at least one Polymer (FP) to at least one surface of a fiber fabric, wherein the polymer powder comprising at least one Polymer (FP) is such that it presents a d₅₀ comprised between 0.1 and 100 μm,
b) sintering the polymer powder on the fiber fabric by means of an electromagnetic radiation, infrared or near-infrared radiation.

The polymer powder may be applied via electrostatic coating.

According to this method the polymer powder is sintered at the surface of the fiber fabric, using an electromagnetic radiation, infrared or near-infrared radiation, for example a high power laser source such as an electromagnetic beam source.

Others methods of the present invention for preparing a composite film presenting a thickness of less than 0.1 mm may start from a polymer material which is in the form of a slurry or a dispersion.

Others methods of the present invention for preparing a composite film presenting a thickness of less than 0.1 mm start from a polymer in the form of a thin film, which can consist of Polymer (FP) described herein or may comprise additional components or additives.

One of these methods for preparing a composite film presenting a thickness of less than 0.1 mm comprises the steps of:
a) applying a polymer film comprising at least one Polymer (FP) to at least one surface of a fiber fabric, wherein the polymer film is such that it presents a thickness of less than 0.09 mm,
b) bonding the polymer film to the fiber fabric at a pressure P of at least 0.3 MPa and/or a temperature T such that T≥ Tm, wherein Tm is the melting temperature of Polymer (FP) (° C.).

Another method for preparing a composite film presenting a thickness of less than 0.1 mm comprises the steps of:
a) applying a polymer film comprising at least one Polymer (FP) to at least one surface of a fiber fabric, wherein the polymer film is such that it presents a thickness of less than 0.09 mm,
b) sintering the polymer film to the fiber fabric, for example by means of an electromagnetic radiation, infrared or near-infrared radiation.

### Method for Preparing the Multi-Layer Composite Film

According to the present invention, several individual composite films may be stacked on each other to prepare a multilayer composite film. The composite films may for example be arranged in the same direction and/or they can be arranged in different directions. If necessary, the stacked multi-layer structure may be subjected to a new cycle (or several cycles) of compression molding using a hot press.

Alternatively, the multilayer composite film may be prepared by:
a) applying the polymer powder comprising at least one Polymer (FP) to at least one surface of at least two fiber fabrics,
b) stacking the at least two fiber fabrics on each other, and
c) bonding the polymer powder to the fiber fabrics at a pressure P of at least 0.3 MPa and/or a temperature T such that T≥Tm, wherein Tm is the melting temperature of the polymer powder (° C.).

Alternatively step c) may consists in sintering the polymer powder, as described above.

In some embodiments, the polymer powder is in the shape of a slurry, for example a wet slurry.

In some other embodiments, the polymer may be in the shape of a thin film (preferably less than 0.09 mm) to be melted in order to bond with the fiber fabric.

Several of these options may be used to prepare one multi-layer composite film according to the invention.

### End-Use Applications

While the composite film of the present invention is characterized by a thickness of less than 0.10 mm, the present invention also relates to assemblies of composite films according to the present invention, which can lead to a final assembly having a thickness above 0.10 mm.

The present invention also relates to an article or component article, comprising at least one composite film as described above, and optionally a metal layer, preferably a copper layer. The metal layer is adhered on at least one of the surfaces of the composite layer.

The present invention also relates to the use of at least one composite film to prepare a mobile electronic device article or component, for example a flexible printed circuit board (FPC).

The composite film of the present invention may notably be used to prepare flexible printed circuit boards (FPC), carrier tapes for tape-automated-bonding (TAB), and tapes of lead-on-chip (LOC) structure.

The present invention also relates to use of a powder of Polymer (FP) to prepare a composite film having a thickness of less than 0.10 mm, said composite film further comprising at least one fiber fabric (F).

### EXAMPLES

The disclosure will be now described in more detail with reference to the following examples, whose purpose is merely illustrative and not intended to limit the scope of the disclosure.

### Starting Materials

Glass Fabric GF-1: Fiberglass® fabric 108, commercially available from BGF Industries, having 48 gsm and 0.06 mm/2.4 mils thickness and a fiber diameter of 5 μm

Glass fabric GF-2: Fabric LD1035-127, commercially available from CTG Taishan Fiberglass; Dielectric Constant Dk @ 1 GHz of 4.3-4.5 and Dissipation factor Df @ 1 GHz of 0.0016, both Dk and Df measured using a transmission line method and a vector network analyzer.

PFA-1: Hyflon® PFA P7010, a tetrafluoroethylene/perfluoroalkylvinylether copolymer commercially available from Solvay Specialty Polymers with a Tm=305° C. and a d₅₀ of 30 μm

PFA-2: Hyflon® PFA P7010, a tetrafluoroethylene/perfluoroalkylvinylether copolymer commercially available from Solvay Specialty Polymers with a Tm=305° C. and a d₅₀ of 150 μm

### Film Preparation Method

The PFA polymer powder was dispersed on the glass fabric (GF-1 or GF-2) in the following configuration: polymer/fabric/polymer. The resulting combination of components was then compression molded into a thin composite film using a hot press set up at a temperature of 330° C. and pressure of 1 MPa. The film was heated for approximately 10 minutes. The polymer powder melted and impregnated the fabric fibers. The film was immediately removed from the press and placed on a cool bench top and allowed to return to ambient temperature. The composition and properties of the composite films are reported in the Results section below.

### Test Methods

### Dielectric Performances (Dk, Df)

The dielectric constant Dk and the dissipation factor Df were measured at 5 GHz by Split Post Dielectric Resonator (SPDR), IEC 61189-2-721:2015 after drying 1 h at 100° C. and after immersion in water for 24 hours.

The dielectric constant Dk and the dissipation factor Df were measured at 20 GHz by Split Cylinder Resonator, IPC TM-650 2.5.5.13 after drying 1 h at 100° C. and after immersion in water for 24 hours.

### Coefficient of Thermal Expansion (CTE)

CTE was measured using a TMA equipment in tension mode ASTM D696.

### Tensile Strength

Tensile test was measured using an Instron® mechanical test machine according to ASTM D882.

### Volume of Fibers

Volume of fibers (Vf) is calculated according to the following equation:

$${V}_{f} = \frac{V olume of fiber}{V olume of fiber + V olume of polymer}$$

### Results

TABLE 1

| | Film #1 |
|---|---|
| Components | PFA-1/GF-1/PFA-1 |
| Vf | 45% |
| Thickness (mm) | 0.075 |
| CTE | 15 |
| Dk 5 GHz after drying 1 h at 100° C. | 3.0 |
| Df 5 GHz after drying 1 h at 100° C. | 0.0035 |
| Dk 5 GHz after immersion in water for 24 h | 3.0 |
| Df 5 GHz after immersion in water for 24 h | 0.0043 |
| Dk 20 GHz after drying 1 h at 100° C. | 2.8 |
| Df 20 GHz after drying 1 h at 100° C. | 0.0080 |
| Dk 20 GHz after immersion in water for 24 h | 2.8 |
| Df 20 GHz after immersion in water for 24 h | 0.0220 |

TABLE 2

| | Film #2 |
|---|---|
| Components | PFA-1/GF-2/PFA-1 |
| Vf* | 26% |
| Thickness (mm) | 0.054 |
| Tensile strength | 93.1 MPa |
| Dk 5 GHz after drying 1 h at 100° C. | 2.3 |
| Df 5 GHz after drying 1 h at 100° C. | 0.0009 |
| Dk 20 GHz after drying 1 h at 100° C. | 2.3 |
| Df 20 GHz after drying 1 h at 100° C. | 0.0018 |
| Dk 20 GHz after immersion in water for 24 h | 2.4 |
| Df 20 GHz after immersion in water for 24 h | 0.0015 |
| Dk 50 GHz after drying 1 h at 100° C. | 2.5 |
| Df 50 GHz after drying 1 h at 100° C. | 0.0020 |
| Dk 75 GHz after drying 1 h at 100° C. | 2.5 |
| Df 75 GHz after drying 1 h at 100° C. | 0.0020 |
| Dk 100 GHz after drying 1 h at 100° C. | 2.4 |
| Df 100 GHz after drying 1 h at 100° C. | 0.0020 |

The data in Table 2, show the excellent dielectric properties of the inventive composite film when the frequency is higher than 10 GHz. The dielectric properties remain consistently good up to 100 GHZ).

TABLE 3

| | Film #3 |
|---|---|
| Components | PFA-2/GF-2/PFA-2 |
| Thickness (mm) | 0.055 |
| Dk 5 GHz after drying 1 h at 100° C. | 2.4 |
| Df 5 GHz after drying 1 h at 100° C. | 0.0010 |
| Dk 20 GHz after drying 1 h at 100° C. | 2.4 |
| Df 20 GHz after drying 1 h at 100° C. | 0.0020 |
| Dk 20 GHz after immersion in water for 24 h | 2.4 |
| Df 20 GHz after immersion in water for 24 h | 0.0020 |

The Dk and Df values of the Film #2 reported in Table 2 when compared to those of Film #3 in Table 3 show that it is possible to further improve the good dielectric properties of the composite films when using fluoropolymer particles with a d₅₀ in the range of 0.1 to 100 μm in the manufacturing process of the composite film.

Better dielectric properties can also be obtained when using a glass fiber fabric having low Dk and Df values, like GF-2.

1. A composite film with a thickness of less than 0.10 mm, comprising:
at least one fluoropolymer comprising recurring units derived from tetrafluoroethylene, Polymer (FP), and
at least one fiber fabric, fiber fabric (F).

2. The composite film of claim 1, wherein Polymer (FP) further comprises recurring units derived from at least one fluorinated monomer different from tetrafluoroethylene selected from the group consisting of:
perfluoroalkylvinylethers of formula CF₂═CFOR_{f} wherein R_{f} is a C1-C6 perfluoroalkyl group;
perfluoro-oxyalkylvinylethers of formula CF₂═CFOX₀ wherein X₀ is a C1-C12 perfluorooxyalkyl group comprising one or more ether groups;
C3-C8 perfluoroolefins; and
perfluorodioxoles of formula (I): 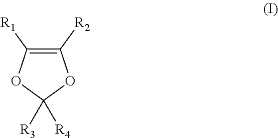
wherein R₁, R₂, R₃ and R₄, equal to or different from each other, are independently selected from the group consisting of—F, a C1-C6 fluoroalkyl group, optionally comprising one or more oxygen atoms, and a C1-C6 fluoroalkoxy group, optionally comprising one or more oxygen atoms recurring units derived from tetrafluoroethylene and less than 10 mol. % of recurring units derived from at least one fluorinated monomer different from tetrafluoroethylene, based on the total number of moles in Polymer (FP).

3. The composite film of claim 1, wherein Polymer (FP) is a tetrafluoroethylene/perfluoroalkylvinylether copolymer comprising:
3.0 to 6.0 mol. % of recurring units derived from a perfluoroalkylvinylether selected from the group consisting of perfluoromethylvinylether, perfluoroethylvinylether and perfluoroproylvinylether, and
from 94.0 to 97.0 mol. % of recurring units derived from tetrafluoroethylene, based on the total number of moles in Polymer (FP).

4. The composite film of claim 1, wherein Polymer (FP) is a per(halo)fluoropolymer having at least 98 mol. % of recurring units derived from tetrafluoroethylene, based on the total number of moles in Polymer (FP).

5. The composite film of claim 1, wherein fiber fabric (F) comprises glass fibers.

6. The composite film of claim 5 wherein the glass fibers are selected from fibers comprising:
i) silicon oxide, 35.0 parts by mass to 48.0 parts by mass; alumina, 1.0 parts by mass to 5.0 parts by mass; titanium oxide 5.5 parts by mass to 10.0 parts by mass; zirconium oxide, 0.5 parts by mass to 4.0 parts by mass; holmium oxide, less than or equal to 3.0 parts by mass; alkaline earth metal oxides, 32.0 parts by mass to 47.5 parts by mass, with respect to the total mass of the fiber; or
ii) silicon oxide, 33.0 parts by mass to 46.0 parts by mass; alumina, 1.5 parts by mass to 5.0 parts by mass; titanium oxide, 5.0 parts by mass to 10.0 parts by mass; zirconium oxide, 0.5 parts by mass to 4.0 parts by mass; neodymium oxide, less than or equal to 2.5 parts by mass; iron oxide, less than or equal to 1.2 parts by mass; alkaline earth metal oxide, 31.0 parts by mass to 53.0 parts by mass, with respect to the total mass of the fiber.

7. The composite film of claim 5, wherein the glass fiber fabric (F) comprising glass fibers is characterized by dielectric constant Dₖ at 1 GHZ, measured using a transmission line method and a vector network analyzer, of less than 5.5 and a dissipation factor D_{f} at 1 GHz, measured using a transmission line method and a vector network analyzer, of less than 0.0030.

8. The composite film of claim 1, wherein the fiber fabric (F) comprises a woven fabric.

9. The composite film of claim 1, wherein the fiber fabric (F) has an average area weight comprised between 10 and 100 g/m².

10. The composite film of claim 1, wherein the film has:
a dielectric constant Dk at 5 GHz equal to or less than 3.5, as measured by Split Post Dielectric Resonator (SPDR), IEC 61189-2-721:2015 after drying 1 h at 100° C., and/or
a dissipation factor Df at 5 GHz of less than 0.0050, as measured by Split Post Dielectric Resonator (SPDR), IEC 61189-2-721:2015 after drying 1 h at 100° C.

11. The composite film of claim 1, wherein the film has:
a dielectric constant Dk at 20 GHz of less than 3.0, as measured by Split Cylinder Resonator, IPC TM-650 2.5.5.13 after drying 1 h at 100° C., and/or
a dissipation factor Df at 20 GHz of less than 0.0100, as measured by Split Cylinder Resonator, IPC TM-650 2.5.5.13 after drying 1 h at 100° C.

12. The composite film of claim 1, wherein the film has:
a dielectric constant Dk at 20 GHz of less than 3.0, as measured by Split Cylinder Resonator, IPC TM-650 2.5.5.13 after immersion in water for 24 hours, and/or
a dissipation factor Df at 20 GHz of less than 0.0300, as measured by Split Cylinder Resonator, IPC TM-650 2.5.5.13 after immersion in water for 24 hours.

13. The composite film of claim 1, wherein the film has:
a Dk 50 GHz of less than 3.0; and/or
a Df 50 GHz of less than 0.0030,
wherein the Dk is measured by Split Cylinder Resonator, IPC TM-650 2.5.5.13 after drying 1 h at 100° C. and the Df is measured by Split Post Dielectric Resonator (SPDR), IEC 61189-2-721:2015 after drying 1 h at 100° C.

14. The composite film of claim 1, wherein the film has:
a Dk 75 GHz of less than 3.0; and/or
a Df 75 GHz of less than 0.0030,
wherein the Dk is measured by Split Cylinder Resonator, IPC TM-650 2.5.5.13 after drying 1 h at 100° C. and the Df is measured by Split Post Dielectric Resonator (SPDR), IEC 61189-2-721:2015 after drying 1 h at 100° C.

15. (canceled)

16. A method for preparing the composite film of claim 1, the method comprising the step of applying a polymer powder comprising at least one Polymer (FP) to at least one surface of a fiber fabric (F).

17. The method of claim 16, comprising the steps of:
a) applying a polymer powder comprising at least one Polymer (FP) to at least one surface of a fiber fabric, wherein the powder comprising at least one Polymer (FP) is such that it has a d₅₀ comprised between 0.1 and 100 μm, and
b) bonding the powder of the at least one Polymer (FP) to the fiber fabric by applying a pressure P of at least 0.3 MPa and/or a temperature T such that T≥Tm, wherein Tm is the melting temperature of the polymer powder (° C.).

18. (canceled)

19. (canceled)

20. The method of claim 16, wherein the fiber fabric (F) is characterized by dielectric constant Dₖ at 1 GHz, measured using a transmission line method and a vector network analyzer, of less than 5.5 and a dissipation factor D_{f} at 1 GHz, measured using a transmission line method and a vector network analyzer, of less than 0.0030.

21. An article or component of an article, comprising at least one composite film according to claim 1, and optionally a metal layer, adhered onto at least one surface of the composite film.

22. A method comprising preparing a mobile electronic device article or component thereof using at least one composite film according to claim 1.

23. A method comprising preparing a composite film from a powder comprising at least one Polymer (FP the composite film having a thickness of less than 0.10 mm, said Polymer (FP) comprising recurring units derived from tetrafluoroethylene (TFE) and said composite film further comprising at least one fiber fabric (F).
